(19) United States
(12) Patent Application Publication
(10) Pub. No.: US 2013/0147943 A1
(43) Pub. Date: Jun. 13, 2013

(54) LIGHTING SYSTEM

(71) Applicants: Yigal Katzir, Rishon Lezion (IL); Tali Hurvits, Ramat Hasharon (IL); David Fisch, D.N. Modi'im (IL); Elie Meimoun, Jerusalem (IL)

(72) Inventors: Yigal Katzir, Rishon Lezion (IL); Tali Hurvits, Ramat Hasharon (IL); David Fisch, D.N. Modi'im (IL); Elie Meimoun, Jerusalem (IL)

(73) Assignee: ORBOTECH LTD., Yavne (IL)

(21) Appl. No.: 13/814,151

(22) PCT Filed: Aug. 2, 2011
(86) PCT No.: PCT/IL11/00624

§ 371 Date: Feb. 4, 2013

Related U.S. Application Data
(60) Provisional application No. 61/370,990, filed on Aug. 5, 2010.

(51) Int. Cl. F21V 5/00; H04N 7/18

(52) U.S. Cl. CPC F21V 5/007
USPC 348/87; 362/227; 362/244

(57) ABSTRACT

A system and method for illuminating an elongated field of view of a linear or high aspect ratio area image sensor comprises providing illumination with an elongated field shape with a plurality of discrete light sources and projecting the illumination toward an object to be imaged; wherein the illumination projected on the object is substantially spatially invariant in intensity and angular distribution along the elongated field shape on the object.

### FIELD OF THE INVENTION

The present invention relates to illumination for Automated Optical Inspection (AOI) of electrical circuits, and more particularly, but not exclusively to illumination for adapted linear or Time Delay and Integration (TDI) type sensors typically used for AOL

### BACKGROUND OF THE INVENTION

AOI systems are typically employed in the inspection of electrical circuits, including Printed Circuit Boards (PCBs), Flat Panel Displays (FPD), chip carriers, integrated circuits and the like. The lighting used preprocesses the image to intensify features that need to be inspected and suppress noise. Advances in lighting have improved the capabilities of vision systems, in part by reducing the computation required by the vision computer. This means that the lighting combinations ideally will improve the image quality to improve the efficiency of the AOI system's decision making process. AOI systems typically have predefined lighting combinations depending upon the mode of operation and type of product being inspected.

The apparent positions of the light sources with respect to the object are important. Angles of illumination are calculated into the inspection algorithms providing enhanced accuracy of the measurements. Also the angle of illumination can be particularly important in certain applications where surrounding objects may interfere with the lighting of the target object. An example would be a tall component on a circuit board that blocks the lighting or the camera system from illuminating/imaging the target component. Another example could be a solder deposit which reduces visualization of some element of the object.

Köhler illumination is a method of specimen illumination used in transmitted- or reflected-light microscopy. Uniformity of light is important to avoid shadows, glare, and inadequate contrast when taking photomicrographs. Köhler illumination overcomes the limitations of earlier methods by creating parallel light rays to pass through the specimen. Since the light rays that pass through the specimen are parallel they will not be in focus when creating the image of the specimen thus eliminating the image of the lamp filament.

True Köhler illumination is obtained when the light source is imaged at infinity with respect to the object. Köhler illumination represents an opposite extreme of another known type of microscope illumination architecture called critical illumination. In critical illumination, the light source is imaged on the object surface.

In contemporary microscopes, Köhler type illumination is obtained by imaging the physical light source (e. g. the lamp filament) into the back focal plane of the objective lens. Since the objective lens exit pupil (image of the aperture stop) in the vast majority of microscope objective optical designs is also located at this plane, well designed microscopes are most often telecentric imagers. By definition the imaging becomes telecentric when the entrance pupil is formed at infinity by the optics. Strictly speaking telecentric imaging is only possible over a field of view that is smaller than the diameter of the entrance pupil. Such a situation is quite customary in microscopy of small objects.

Though there are many advantages to telecentric imaging in optical inspection systems, practical PCB or FPD inspection systems are seldom telecentric due to the camera field of view being typically much wider than the entrance pupil of the imaging lens. In situations where a specularly reflecting object such as an FPD is illuminated with a narrow-angle source, the illumination is progressively vignetted towards the edges of the field. As a result different parts of the field of view are imaged by different parts of the light source's angular field. To overcome vignetting the source angular field is frequently made overly broad, thus leading to loss of contrast, poor light utilization efficiency and much stray light.

Another useful feature found in many incident-light microscopes is selectable bright- or dark-field illumination. By definition bright-field illumination corresponds to the more common situation where the illuminating light rays all enter the imaging lens entrance pupil after reflection by a specularly reflecting substrate. Dark field illumination results when the substrate is illuminated only with light rays that impinge outside of the entrance pupil after being reflected by a flat substrate. In dark field mode only edges and other surface irregularities reflect light into the camera, and is therefore useful for enhancing such features for purposes of inspection.

In some known energy-efficient illumination architectures for producing elongate lighting shape, an effective light source is substantially focused at least in one direction, e.g. using a cylindrical concentrator. Such prior-art illuminators may be characterized as “critical” in one direction.

### SUMMARY OF THE INVENTION

An aspect of some embodiments of the invention is the provision of a lighting system that projects quasi-Lambertian emission over an elongated field of view such as that of a linear or TDI type camera. According to some embodiments of the present invention, projection over an elongated field of view is achieved with an array of Köhler-like illuminations. As defined herein, Köhler-like illumination refers illumination that is not critical in any direction.

The illumination according to some embodiments of the invention is Kohler-like in the sense that a physical light-emitting surface, e.g. an effective light source (but not necessarily in itself a physical light source) is imaged into an imaging lens as opposed to being imaged at an object surface. In some exemplary embodiments the effective light source is imaged into an imaging lens's entrance pupil, which is not located at infinity. As a result, light rays coming from each effective light source point are not strictly parallel or collimated as they impinge on the object, but rather converge into the imaging lens's entrance pupil.

Typically, since the distance between a target object and the imaging lens's entrance pupil is substantially larger than a diameter of the entrance pupil, e.g. an order of magnitude larger the Köhler -like illumination may be considered substantially collimated.

According to some embodiments of the present invention, the Köhler -like illumination is both uniform and non-vignetting over an elongated area. As defined herein an elongated area is an area with an aspect ratio of about 10:1 or more, e.g. an aspect ratio greater than 6:1. Typically the target object is illuminated over an area that straddles and overfills the field of view of the camera with a safety margin to allow for mechanical and system tolerances. Typically, the majority of the overfill is provided along the narrower dimension. Optionally, the safety margin ranges for example from two times greater than the narrower dimension to 100 times greater or more. For example, in the case of linear sensors the field of view may have a narrow dimension of 10 μm while the narrow dimension of the illuminated region on the object may have a length of 1 mm. In another example, in the case of a TDI or like sensor, e.g. with 100 lines, the field of view may have a narrow dimension of approximately 1 mm while the narrow dimension of the illuminated region on the object may have a length of about 2 to 3 mm. Optionally, less overfill is possible with a greater aspect ratio, for example by increasing the number of discrete light sources in the array of discrete light sources.

In some exemplary embodiments, the array of Köhler-like illuminations is constructed from an array of discrete light sources coupled to an array of lenses. Typically, the lenses in the array are positioned side-by-side with no space between them to provide substantially spatially invariant illumination over the elongated field of view. As used herein, spatially invariant illumination refers to illumination with an angular field or “sky of illumination” that is the same for all points within an illuminated area as observed from any point within the illuminated area.

According to some embodiments of the present invention, each Köhler-like illumination in the array projects a discrete portion of the “sky of illumination” to a target object, that portion having a same shape as the shape of its light source. If each of the discrete light sources emits with a same shape and intensity, the result is a continuous, e.g. spatially invariant angular field as observed from the target object where every point on the illuminated region receives a same illumination.

In some exemplary embodiments, the array of discrete light sources is replaced and/or coupled with an array of Spatial Light Modulators (SLMs). The SLMs provide for optionally modified properties of its light source on demand as required for different applications. Optionally, SLM is used to alternately provide bright and/or dark field illumination during imaging.

According to some embodiments of the present invention, the lighting system includes a field lens to angle and direct illumination emitted through the lens array toward the imaging pupil of the imaging system.

An aspect of some embodiments of the present invention provides for a method for illuminating an elongated field of view of a linear or high aspect ratio area image sensor, the method comprising: providing illumination with an elongated field shape with a plurality of discrete light sources; and projecting the illumination toward an object to be imaged; wherein the illumination projected on the object is substantially spatially invariant in intensity and angular distribution along the elongated field shape on the object.

Optionally the method comprises imaging the projected illumination to an imaging lens entrance pupil of an imaging unit for imaging the object, wherein a diameter of the entrance pupil is at least one order of magnitude less than a distance between the object and the imaging lens.

Optionally, the field of view of the imaging sensor has an aspect ratio larger than 40:1.

Optionally, the illumination is non-vignetting over the elongated field of view.

Optionally, the illumination provided is adapted to non-telecentric imaging of the elongated field of view.

Optionally, the illumination provided is output from an SLM.

Optionally, the illumination provided is dark field illumination with a ring shaped angular distribution.

Optionally, the illumination with an elongated field shape is provided with an array of light sources projected through an array of lenses, wherein the lenses in the array are contiguous with no space between them.

Optionally, each light source and corresponding lens projects a discrete portion of illumination toward the elongated field of view with an angular shape substantially similar to the shape of the light source and wherein the discrete portions of illumination are contiguous with substantially no space between them and provide illumination over the elongated field of view.

Optionally, illumination projected from each light source through each corresponding lens of the array of light sources and the array of lenses is Köhler-like illumination.

Optionally, the method comprises directing illumination projected through all the lenses of the lens array into the imaging lens aperture of an image sensor.

Optionally, the directing is provided with a field lens.

Optionally, the field lens is a plano-convex lens.

Optionally, the field lens is a Fresnel lens.

Optionally, the light sources of the array are narrow angle light sources each of which emit over a total angle of 25 to 35 degrees.

Optionally, an aspect ratio of the array of lenses is less than 10:1.

Optionally, the array of light sources is an array of LED lamps.

Optionally, the array of light sources projected from an array of optical fiber bundles.

Optionally, the method comprises feeding all the optical fiber bundles from a single central light source.

Optionally, the central light source includes a SLM that defines a shape of light emitted by the central light source.

Optionally, the array of light sources is formed with a SLM based integrated projection light engine.

Optionally, the SLM provides one of bright field or dark field illumination. Optionally, the SLM provides dark field illumination with a ring shaped illumination formed with the SLM.

Optionally, an inner diameter of the ring shaped illumination is defined to be equal to or larger than the entrance pupil of an imaging lens for imaging the elongated field of view.

Optionally, the SLM provides bright field illumination with a circular shaped illumination formed with the SLM, wherein a diameter of the circular shaped illumination is equal or smaller than entrance pupil of an imaging lens for imaging the elongated field of view.

An aspect of some embodiments of the present invention provides for a lighting system for illuminating an elongated field of view of a linear or high aspect ratio area image sensor: an array of lenses, wherein the lenses in the array are contiguous with no space between them; an array of light sources, each having a shape, wherein each light source in the array of light sources is positioned to project light through a corresponding lens in the array of lenses; and wherein each light source and corresponding lens projects a discrete portion of illumination toward the elongated field of view with an angular shape substantially similar to the shape of the light source and wherein the discrete portions of illumination are contiguous with substantially no space between them and provide illumination over the elongated field of view.

Optionally, each light source and corresponding lens of the array of light sources and the array of lenses provides Köhler-like illumination.

Optionally, the light sources of the array are narrow angle light sources each of which emit over a total angle of 25 to 35 degrees.

Optionally, the elongated field of view has an aspect ratio larger than 40:1.

Optionally, an aspect ratio of the array of lenses is less than 10:1.

Optionally, the illumination from the array of light sources is imaged onto an imaging lens entrance pupil of an imaging unit for imaging the object, wherein a diameter of the entrance pupil is at least one order of magnitude less the a distance between the object and the imaging lens.

Optionally, the lighting system further comprises a field lens, wherein the field lens is adapted to direct illumination projected through all the lenses of the lens array into the imaging lens aperture of an image sensor.

Optionally, the field lens is a plano-convex lens.

Optionally, the field lens is a Fresnel lens.

Optionally, the array of light sources is angled in a crescent shape, said crescent defined to direct illumination into an imaging lens aperture of an image sensor.

Optionally, the array of lenses are angled in a crescent shape, said crescent shape defined to direct illumination into an imaging lens aperture of an image sensor.

Optionally, the array of light sources is an array of LEDs.

Optionally, the array of light sources is output from an array of optical fiber bundles.

Optionally, all the optical fiber bundles in the array project illumination feed from a central light source.

Optionally, the central light source includes a SLM and wherein the light emitted has a shape defined by the SLM.

Optionally, the array of light sources is output from an array of SLMs.

Optionally, the array of light sources is formed with a SLM based integrated projection light engine.

Optionally, the SLM provides one of bright field or dark field illumination.

Optionally, the SLM provides dark field illumination with a ring shaped illumination formed with the SLM.

Optionally, an inner diameter of the ring shaped illumination is defined to be equal to or larger than the entrance pupil of an imaging lens for imaging the elongated field of view.

Optionally, the SLM provides bright field illumination with a circular shaped illumination formed with the SLM, wherein a diameter of the circular shaped illumination is equal or smaller than entrance pupil of an imaging lens for imaging the elongated field of view.

Optionally, all the light sources in the array are identical.

Optionally, all the lenses in the array are identical.

Optionally, the lenses in the array are spherical lenses.

Optionally, the lighting system is adapted to non-telecentric imaging of the elongated field of view.

An aspect of some embodiments of the present invention provides for a method for scanning a substrate in an automated optical inspection system, the method comprising: providing a substrate; illuminating the substrate according to the methods described herein above; imaging the substrate; analyzing output from the imaging to identify defects in the substrate; reporting the defects.

Optionally, the method comprises illuminating the substrate with a plurality of illumination configurations.

Optionally, the plurality of illumination configurations includes at least one of dark field and bright field illumination.

An aspect of some embodiments of the present invention provides for an automated optical inspection system comprising: an imaging unit comprising at least one camera and at least one illumination unit, wherein the at least one illumination unit described herein above; a scanning unit configured for providing translation between a substrate for inspection and the imaging unit; a controller configured for coordinating translation of the scanning unit, illumination of the at least one illumination unit and image capture of the at least one camera.

Optionally, the at least one illumination unit is adapted to provide a plurality of illumination configurations.

Optionally, the plurality of illumination configurations includes at least one of dark field and bright field illumination.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is an exemplary schematic diagram of optical components of a lighting system for illuminating an elongated field of view in accordance with some embodiments of the present invention;

FIGS. 2A and 2B are exemplary schematic diagrams of an optical design for the lighting with imaging system in two orthogonal planes in accordance with some embodiments of the present invention;

FIG. 3 is an exemplary schematic diagram of alternate optical components of a lighting system in accordance with some embodiments of the present invention;

FIGS. 4A and 4B are exemplary schematic diagrams of an optical design in two different planes based on the alternate optical components in accordance with some embodiments of the present invention;

FIG. 5 is an exemplary schematic diagram of an optical design for the lighting system that uses a beam splitter in accordance with some embodiments of the present invention;

FIG. 6 is a simplified schematic diagram of an alternate optical design for the lighting system that does not require beam splitting in accordance with some embodiments of the present invention;

FIG. 7A is an exemplary schematic diagram of a fiber optic unit of the lighting system in accordance with some embodiments of the present invention;

FIGS. 7B and 7C are exemplary schematic diagrams of a mechanical structure of the lighting system in accordance with some embodiments of the present invention;

FIG. 7D is a cross section schematic view of an exemplary optical fiber bundle in accordance with some embodiments of the present invention;

FIG. 8A is an exemplary schematic diagram of optical components of a SLM based lighting system for illuminating an elongated field of view in accordance with some embodiments of the present invention;

FIG. 8B is an exemplary schematic diagram of optical components of a SLM light source feeding into an optical fiber bundle of a lighting system in accordance with some embodiments of the present invention;

FIGS. 8C and 8D show SLM images used to provide dark field illumination and bright field illumination respectively in accordance with some embodiments of the present invention;

FIGS. 9A and 9B is an exemplary schematic diagram of a lighting path and output of a SLM based lighting system over an area on the target object bordering between two neighboring lenses of the lighting system in accordance with some embodiments of the present invention;

FIG. 10 is an exemplary schematic diagram of a SLM based light system with an integrated projection light engine in accordance with some embodiments of the present invention;

FIG. 11 is an exemplary block diagram of a scanning system for AOI that includes a lighting system in accordance with some embodiments of the present invention; and

FIGS. 12A and 12B show irradiance received on entrance pupil in an exemplary simulation using the lighting system in accordance with some embodiments of the present invention.

### DESCRIPTION OF SPECIFIC EMBODIMENTS OF THE INVENTION

The present invention relates to illumination for Automated Optical Inspection (AOI) of electrical circuits, and more particularly, but not exclusively to illumination adapted for linear or TDI type sensors typically used for AOI.

Energy efficiency and programmability in illumination are important aspects in AOI. With regard to energy efficiency, during AOI, an image of the inspected substrate is sequentially captured line by line with linear or TDI type sensors. Whereas the inspected substrate typically measures between 0.5 m by 0.5 m to 3 m by 3 m, the instantaneous field of view of those sensors is typically 40 mm to 100 mm wide by 0.005 μm to 1000 μm long, some aspects of the invention can also be applied to larger or smaller substrates. Accordingly, an elongated region to be illuminated generally has an aspect ratio of between 40 to 1 and 150 to 1.

If the shape of the illuminated region does not match the elongated shape of the camera field of view, much of the energy used for illumination may be wasted and the energy efficiency of the lighting system can be severely reduced. For example, if the shape of the illuminated region is a single circular region designed to cover the elongated region, most of the energy used for illumination will be wasted.

One important aspect in illumination for AOI is uniformity of light. Uniformity of light is typically important to avoid shadows, glare, and inadequate contrast that may hinder proper inspection of a panel. Köhler illumination has been used in microscopy, e.g. when capturing photomicrographs to overcome such limitations by creating parallel light rays to pass through the specimen. Typically, in microscopy the field of view required to be illuminated is a circular field of view and/or a field of view with an aspect ratio around 1.

Another important aspect in illumination for AOI is versatility. Typically, different types of applications require different types of illumination. For example, some applications require bright field illumination, while others require dark field illumination. Additionally and independently, different combinations of wavelengths and intensity of illumination may be used for different applications. Incorporating SLMs, typically of transmissive LCD type, in the aperture plane of microscope illuminators, has enabled programmable selection of the angular field of the light projected to the inspected substrate.

An aspect of some embodiments of the present invention provides illumination with an elongated field shape that is substantially spatially invariant over a two dimensional elongated field. According to some embodiments of the present invention, the elongated field shape substantially matches the shape and size of the field of view of an associated imager. Typically, the elongated field shape covers an area that is larger than a field of view of the associated imager.

According to some embodiments of the present invention, the illumination provides a substantially same angular field of illumination at every point in the elongated illuminated region. Preferably, the illumination is substantially uniform over the field of illumination. The elongated shaped illumination is provided by an array of Köhler -like illuminations.

In some exemplary embodiments, each Köhler-like illumination is constructed from a discrete light source coupled to a lens. The illumination formed by these embodiments is Köhler-like in the sense that each discrete light source is imaged into the entrance pupil of the imaging lens. Typically an entrance pupil measuring approximately 20 mm is located at a distance of about 250 mm away from the object. Since that distance is typically an order of magnitude greater than the pupil, the illumination may be considered substantially collimated. The inventors have found that in such embodiments the illumination is additionally relatively vignetting-free, is substantially shift invariant and could for example have a distinct transition between bright field and dark field illumination modes.

According to some embodiments of the present invention, the lenses in the array of Köhler-like illuminations are provided in a unitary array with no spaces between the lenses and provide substantially spatially invariant illumination with the discrete light sources over an elongated field of view. Optionally, the lens array is single unit and is manufactured by injection molding. The present inventors have found that the array of Köhler-like illuminations provide excellent light efficiency over an elongated illuminated field.

According to some embodiments of the present invention, the discrete light sources are Light Emitting Diodes (LEDs) and/or LED lamps. Optionally, the light sources are narrow angle light sources, e. g. optical fiber light guides coupled to lamps/reflector combinations typically emitting over a total angle of 25 to 35 degrees. The present inventors have found that using narrow angle light sources improves controllability of the angular field of illumination. According to some embodiments of the present invention, the lighting system provides for easily altering parameters of the lighting, e.g. color, shape and intensity of light without altering the illumination optics associated with the lighting system. According to some embodiments of the present invention, the angular range of the illumination received from the light source remains substantially constant in the light system.

According to some embodiments of the present invention, the array of discrete light sources can be replaced and/or coupled to an array of SLMs. Optionally, the SLMs are one of a Digital Micromirror Device (DMD), Liquid Crystal on Silicon (LCoS) type and/or LCD. According to some embodiments of the present invention, the SLMs are used to project different angular fields on demand, e.g. dark field illumination and/or bright field illumination. The present inventors have found that illuminating via an array of SLMs coupled with specially designed optical architecture as described herein can provide fully programmable, e.g. software programmable angular field and/or light spectrum at every point inside of an elongate field. Software programmable light is typically associated with good field reliability since mechanically moving parts and/or different optical assemblies are not required.

In some exemplary embodiments, each discrete light source is formed with a SLM based integrated projection light engine. Optionally, for embodiments using a SLM based integrated projection light engine, a relay lens is used to form an image either real or virtual at the appropriate location relative to each lens of the lens array.

According to some embodiments of the present invention, the light system additionally includes a field lens adapted to converge multiple illumination segments obtained from the lens array into the imaging lens aperture to achieve the Köhler-like illumination effect over the elongate field optionally while using a non-telecentric imaging lens. Optionally, the field lens is omitted and instead, the light sources and/or SLMs are angled and directed toward the imaging lens aperture. Optionally and additionally, optical characteristics of the lenses of the lens array are adjusted and the array is curved to direct illumination toward the imaging lens aperture. In some exemplary embodiments, a beam splitter is used to illuminate a target region. Optionally, an oblique optical axis is provided so that a beam splitter is not required.

In some other exemplary embodiments the effective light sources are imaged to infinity relative to the inspected object. The image of the light sources therefore by definition now forms at the back focal plane of the imaging lens, which does not necessarily coincide with the exit pupil. In such embodiments each point of the light source gives rise to a collimated plane wave incident on the object. In combination with a SLM, such architectures may be useful for precisely controlling the angular shape of the incident illumination, since each SLM pixel generates a well defined illumination angle. Such an illumination mode may have some limitations arising from vignetting, e.g. inferior spatial and angular uniformity.

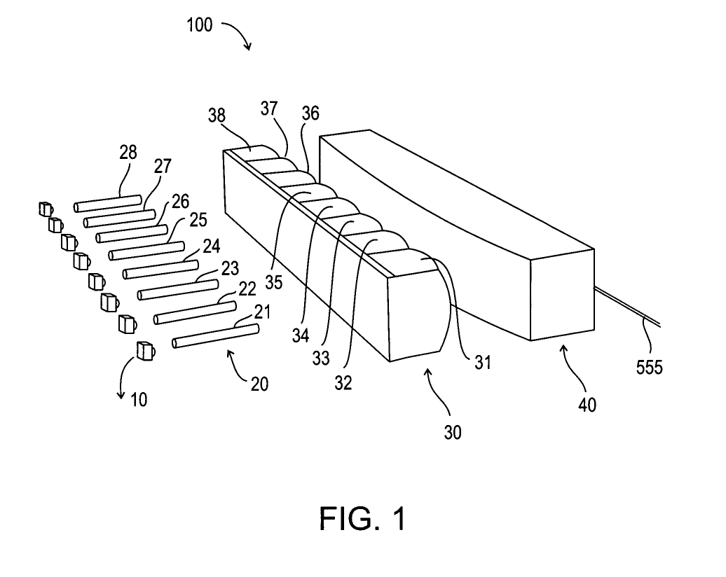

Reference is now made to FIG. 1 showing an exemplary schematic diagram of optical components of a lighting system for illuminating an elongated field of view in accordance with some embodiments of the present invention. According to some embodiments of the present invention, a lighting system for AOI includes one or more light sources 10 that project light through an array of optical fiber bundles 20 toward a lens array 30. Outputs from the optical fiber bundles 20 serve as effective light sources when illuminated by the physical light source(s) 10. According to some embodiments of the present invention, array of optical fiber bundles 20 includes optical fiber bundles 21 . . . 28 and lens array 30 includes a corresponding array of lenses 31 . . . 38. Optionally, an array of 4-12, e.g. 8 effective light sources and lenses is used to illuminate an elongated field of view 555 of a linear sensor or the like used for scanning a substrate, e.g. a panel. Optionally, each optical fiber bundle includes 5-16 optical fibers and/or optical light guide ends, e.g. 8 optical fibers. Optionally, optical fiber bundles have a diameter between 1-3 mm, e.g. 1.4 mm diameter. Optionally, the effective light sources are defined by an array of pinholes in front of the fiber bundle ends and illuminated by those ends. Optionally, the optical fiber bundles 20 (also referred to here as discrete effective light sources) are separated by suitable light absorbing baffles (not shown) to minimize crosstalk or light leakage between neighboring source/lens pairs. Typically, the optical fibers in each bundle are arranged to have a circular-like cross section. Typically, the optical fibers transmit light with a same angular distribution as light source 10.

According to some embodiments of the present invention, lens array 30 is an array of alike spherical lenses 31 . . . 38 that are positioned side-by-side with no space between them. Optionally, the lenses are aspheric, plano-spheric or up to double aspheric. In some exemplary embodiments, the lenses in the array are arranged in a linear fashion. Typically the aspect ratio of the lens array is about 1:10 and is generally an order of magnitude less than the aspect ratio of the field of view of the camera. The significantly small aspect ratio of the lens array has the advantage of easing mechanical assembly requirements, while energy waste penalty is relatively insignificant. According to some embodiments of the present invention, lens array 30 can be a single unit manufactured for example by injection molding.

According to some embodiments of the present invention, output from each optical fiber bundle (the effective light source), e.g. from optical fiber bundles 21 . . . 28 emitted through its corresponding lens, e.g. from lens 31 . . . 38 provides a Köhler-like illumination and output from an array of optical fiber bundles 20 emitting through lens array 30 provide an array of Köhler-like illuminations. Each Köhler-like illumination segment in the array illuminates a partial region on a target object 50 (e.g. panel, substrate). To an observer located within that region the illuminating segment projects an angular field with a same shape as the illumination shape of its effective light source. According to some embodiments of the present invention, the discrete illuminated regions are contiguous regions with no space between them. According to some embodiments of the present invention all effective light sources e. g. those formed by the output ends of fibers 21 . . . 28 have substantially identical shape. In such embodiments all angular fields projected to the contiguous object regions all blend seamlessly into a single shift-invariant angular field over the whole illuminated region. This is explained in more details herein below.

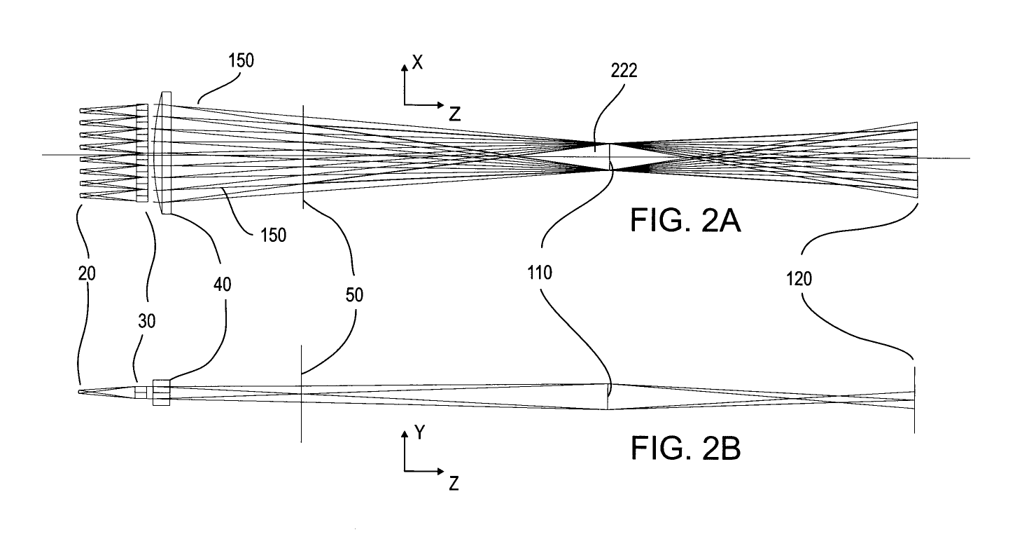

According to some embodiments of the present invention, a field lens 40 receives light from lens array 30 and directs them to an entrance pupil of imaging lens 110 (FIG. 2A) of an imaging system. In some exemplary embodiments, field lens 40 is a single spherical strip-like lens that directs light from all lenses of lens array 30. Typically field lens 40 is a plano-convex lens. In some exemplary embodiments field lens 40 is a Fresnel lens offering reduced cost and weight while introducing certain degradation to the projected source image quality. Although field lens 40 is shown to be positioned between lens array 30 and target object 50, optionally field lens 40 is positioned between target object 50 and the entrance pupil of the imaging system. According to some embodiments of the present invention, a size of illumination area is adjusted by adjusting relative positions of lens array 30 and field lens 40 such that the source is imaged onto a plane of the entrance pupil of the imaging system.

Reference is now made to FIGS. 2A and 2B showing exemplary schematic diagrams of an optical design for the lighting with imaging system in two orthogonal planes in accordance with some embodiments of the present invention. The light and imaging paths shown in FIGS. 2A and 2B are unfolded for clarity. According to some embodiments of the present invention, imaging the effective light sources 20 into the aperture of imaging lens 110 is performed by a combined action of an array of spherical lenses 30 and a spherical strip-like field lens 40. Optionally, lenses 30 are aspheric or other shaped lenses, e.g. plano-spheric or double aspheric. According to some embodiments of the present invention, illuminating rays 150 specularly reflected from target object 50 and converge at the aperture of an imaging lens 110 for imaging on linear sensor 120. In some exemplary embodiments, without field lens 40, all light sources would be imaged in parallel direction to each other and formed at the plane of the imaging lens 110 aperture at either side of an optical axis 222. In some exemplary embodiments, field lens 40 serves to converge all the light sources images into the aperture of imaging lens 110 to achieve Köhler-like illumination effect provided by light source 10 and lens array 30 over an elongated field while using a non-telecentric imaging lens.

According to some embodiments of the present invention, the imaging lens images a part of target object 50 to be scanned into linear sensor 120. Typically, the part of the panel being imaged is entirely illuminated with the elongated continuous region having a desired angular coverage. Light from the part of target object 50 to be scanned is directed to the linear sensor 120 through entrance pupil of imaging lens 110. Bright field illumination is provided when an image of the light source on imaging lens 110 is equal to or smaller than entrance pupil associated with imaging lens 110. Dark field illumination is an illumination that does not reach the entrance pupil by specular reflection from the object. According to some embodiments of the present invention, dark field illumination is effected by a generally ring shaped illumination formed from a ring of sources, such that the inner diameter of the ring shaped source as is imaged in the plane containing the aperture of imaging lens 110 is equal to or larger than the entrance pupil of the imaging lens 110. By definition, entrance pupil of imaging lens 110 is the effective “window” (or aperture) through which light is collected by the imaging lens. Different shaped illumination is discussed in more detail herein below.

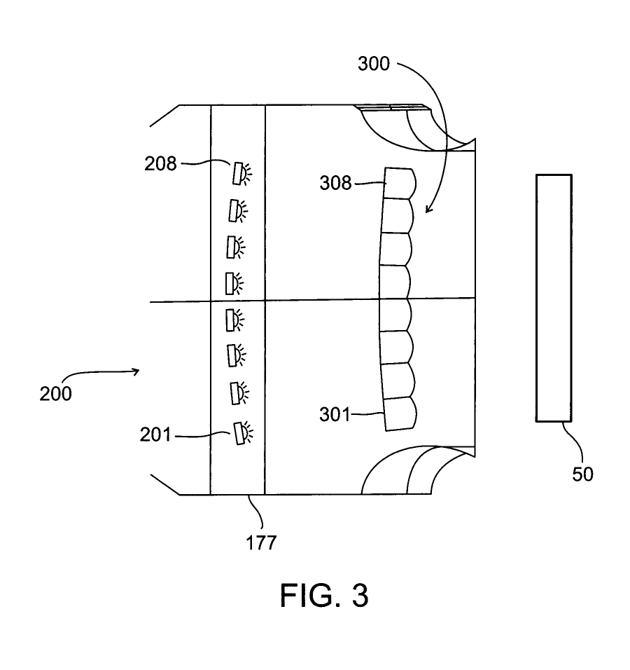

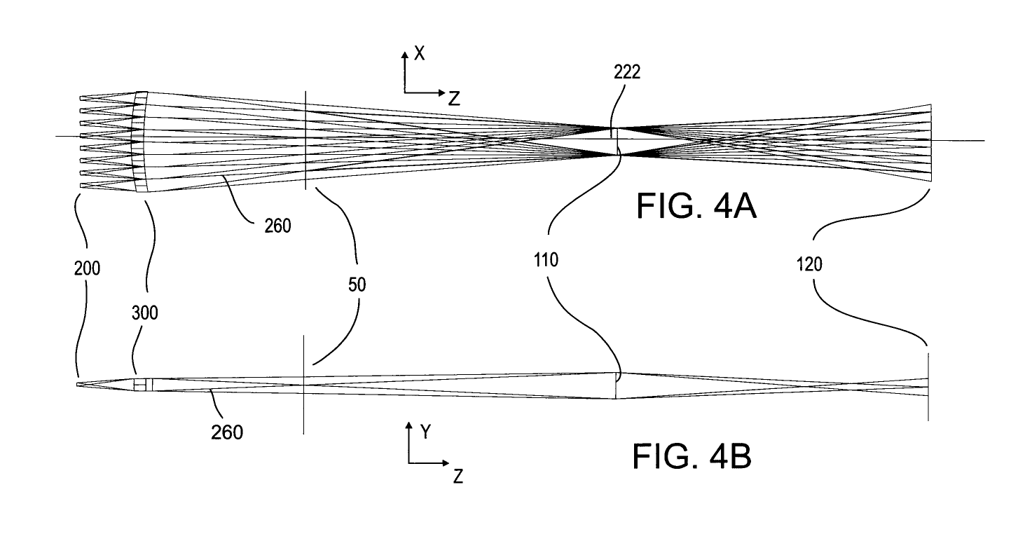

Reference is now made to FIG. 3 showing an exemplary schematic diagram of alternate optical components of a lighting system and FIGS. 4A and 4B showing exemplary schematic diagrams of an optical design in two different planes based on the alternate optical components all in accordance with some embodiments of the present invention. According to some embodiments of the present invention, illumination is directed toward an imaging lens 110 and/or imaging lens aperture after specular reflection off of target object 50 without requiring a field lens. According to some embodiments of the present invention, each of an array of discrete light sources 200 and a corresponding array of lenses 300 are arranged in a crescent shape adapted to converge illumination toward imaging lens 110. In some exemplary embodiments, discrete light sources 201 . . . 208 of array of discrete light sources 200 are mounted in a housing 177 on a surface that is slightly curved inward toward lens array 300. It is noted that discrete light sources 201 . . . 208 represent the effective light sources formed by one of LED lamps, physical output ends of optical fibers or other suitable homogenizing light guides, a real plane of a physical SLM, and/or real or virtual image of a physical SLM. In some exemplary embodiments, lenses 301 . . . 308 of lens array 300 are non-identical lenses and their individual optical characteristics provide for bending light toward the imaging optics. In some exemplary embodiments lens array 300 is an integral array of lenses with no space between. Optionally, lens array 300 manufactured as a single integrated unit with plastic injection molding. According to some embodiments of the present invention, a cone of rays 260 emitted through lens array 300 progressively bends toward the entrance pupil of imaging lens 110.

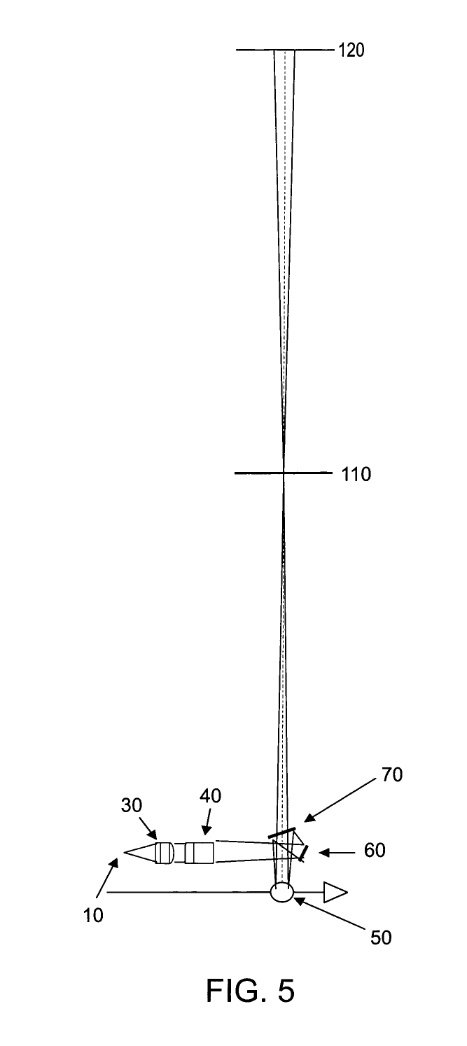

Reference is now made to FIG. 5 showing an exemplary schematic diagram of an optical design for the lighting system that uses a beam splitter in accordance with some embodiments of the present invention. According to some embodiments of the present invention, the optical axis of the lighting system is perpendicular to target object 50 and a reflector 60 together with a beam splitter 70 is positioned to direct illumination from illumination source(s) 10 toward target object 50 and project light reflected from target object 50 through beam splitter 70 toward an imaging unit. Optionally the beam splitter is a pellicle beam splitter.

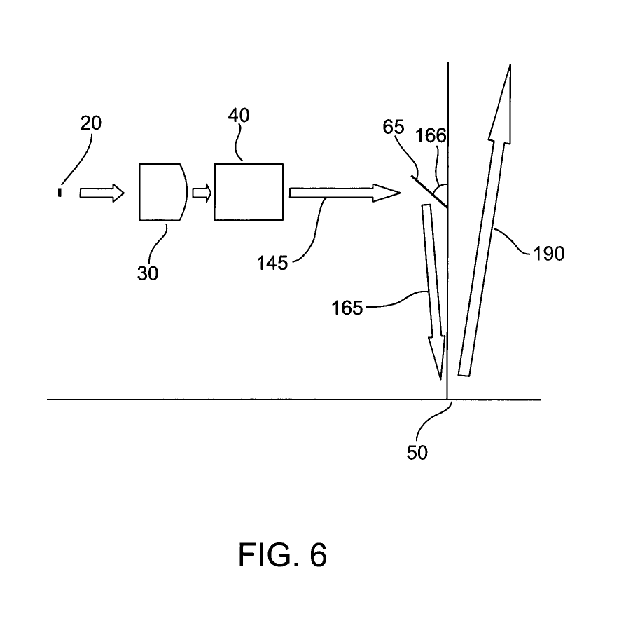

Reference is now made to FIG. 6 showing a simplified schematic diagram of an alternate optical design for the lighting system that does not require beam splitting in accordance with some embodiments of the present invention. According to some embodiments of the present invention, the optical axis of illumination is made oblique rather than perpendicular to the target object 50 so that a beam splitter is not required. Removing the beam splitter substantially improves light efficiency. In some exemplary embodiments, removing the beam splitter improves efficiency by approximately fourfold.

According to some embodiments of the present invention, an effective array of light sources 20 emits light through a lens array 30 and optionally through a field lens 40 toward a reflecting surface 65 that bends rays originally propagating in direction 145 towards target object 50 along direction 165 so that the illumination is not normally incident. Optionally reflecting surface 65 is positioned at an angle 166 that is somewhat greater than 45 degrees. Once reflected off an area of target object 50, the light beams are directed in an oblique angle in direction 190 toward an imaging lens and imaging sensor.

According to some embodiments of the present invention, the oblique (no beam splitter) inspection architecture as described herein is particularly useful in combination with linear array sensors and includes all the useful illumination features of the vertical architectures described herein. Additionally, the oblique (no beam splitter) inspection architecture described herein is particularly suitable for imaging highly flat surfaces or in combination with a suitable automatic focusing mechanism.

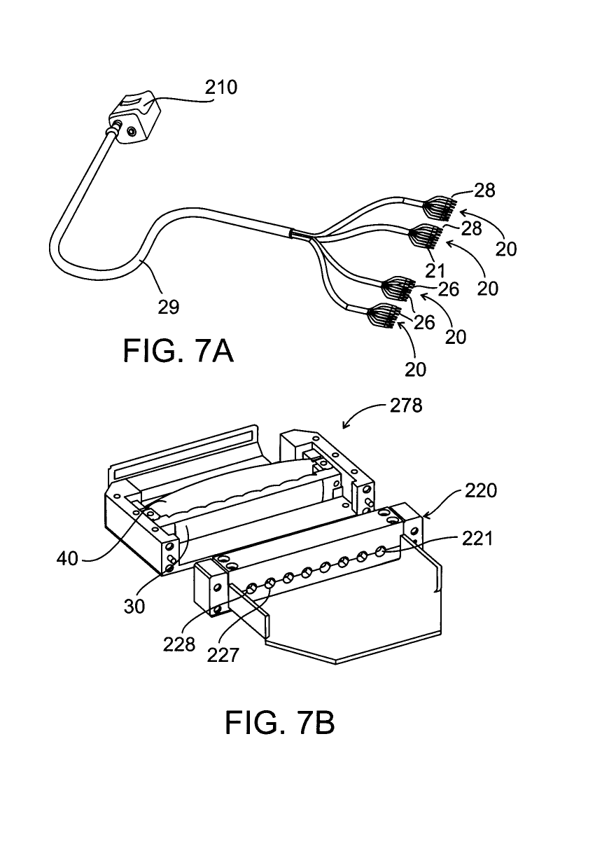

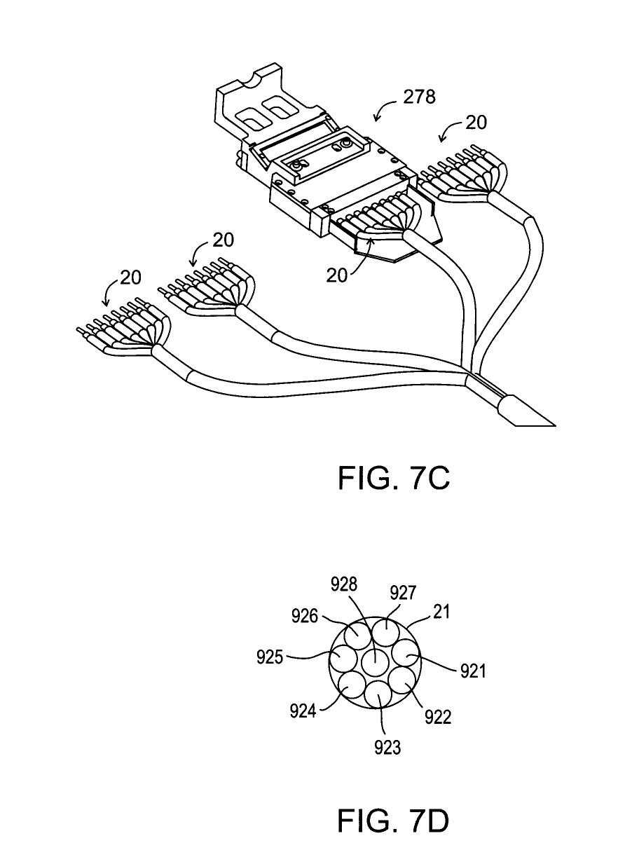

Reference is now made to FIG. 7A showing an exemplary schematic diagram of a fiber optic unit of the lighting system, FIGS. 7B and 7C showing exemplary schematic diagrams of a mechanical structure of the lighting system and FIG. 7D showing a cross section schematic view of an exemplary optical fiber bundle, all in accordance with some embodiments of the present invention. According to some embodiments of the present invention, one or more array of optical fiber bundles 20 is provided to illuminate a field of view of one or more cameras during scanning. According to some embodiments of the present invention, each array of optical fiber bundles 20 includes optical fiber bundles 21 . . . 28. Optionally, each optical fiber bundle, e.g. fiber bundle 21 includes 1000-2000 optical fibers and/or optical light guide ends, e.g. 8 optical fibers 921 . . . 928 (only 8 optical fibers are shown for simplicity in illustration). Optionally the optical fibers in the bundle are arranged so as to have a bundle with a substantially circular cross section (FIG. 7D).

According to some embodiments of the present invention, a single light source 210 having a predefined shape and angular distribution is used as input to the optical fiber bundles. In some exemplary embodiments, light source 210 is remote from an imaging site and an optical fiber bundle 29 is used to transmit illumination toward the imaging site, its ends 20 comprising effective sources in various embodiments of the invention as explained hereinabove. According to some embodiments of the present invention a plurality of cameras, e.g. an array of cameras are used during scanning of a target object and each optical fibers bundle array 20 together with optics housed in hosing 278 illuminates a field of view of one of the cameras.

According to some embodiments of the present invention a housing 278 includes an optical fiber bundle receiving unit 220 featuring a plurality of through going holes 221 . . . 228 for receiving and aligning each of the fiber bundles in array 20 with the optical system. Typically housing 278 includes a slot for receiving and aligning lens array 30, and field lens 40. In some exemplary embodiments, housing 278 additionally houses a folding mirror 60 and beam splitter 70 shown schematically in FIG. 5. As shown in FIG. 5 the folding mirror, e.g. an ordinary flat mirror deviates light from its original horizontal propagation and throws it upwards in the direction of the beam splitter. Optionally, this allows the beam splitter to be mounted at a minimum oblique angle relative to the optical axis, which minimizes optical interferences. In some exemplary embodiments a folding mirror is not used and instead the panel is illuminated directly by either reflection or transmission by the beam splitter.

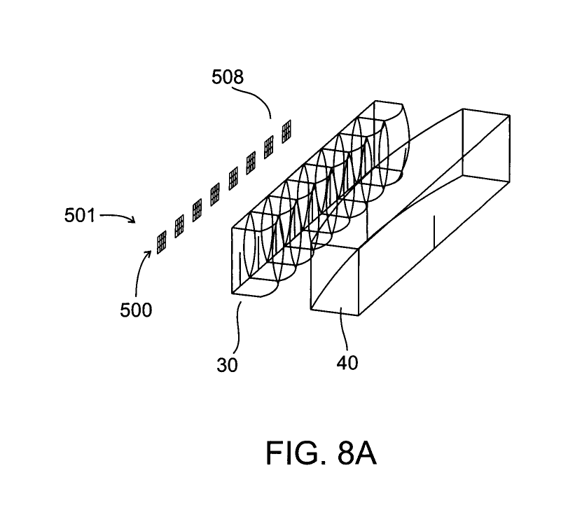

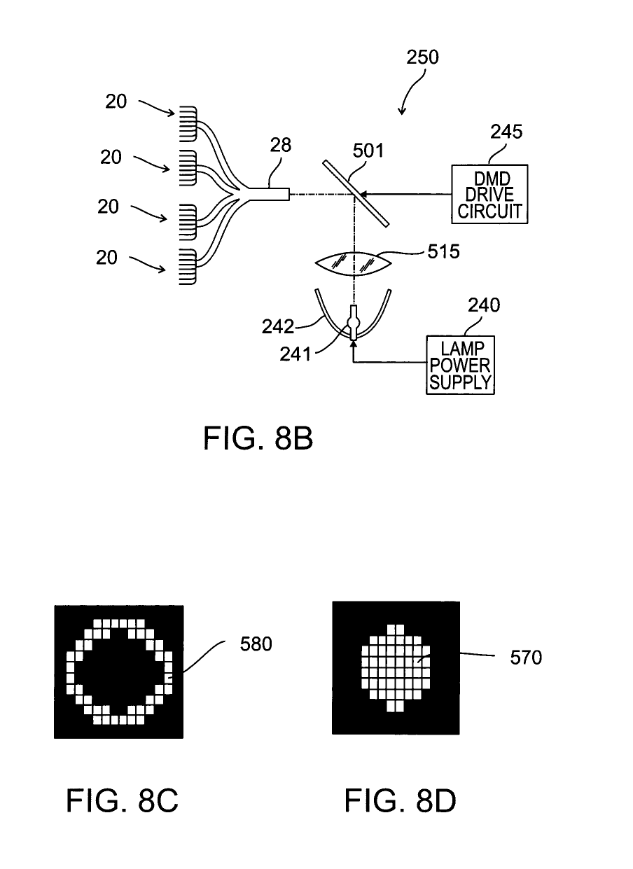

Reference is now made to FIG. 8A showing an exemplary schematic diagram of optical components of a SLM based lighting system for illuminating an elongated field of view in accordance with some embodiments of the present invention. According to some embodiments of the present invention, the array of effective light sources is obtained from real planes of an array of SLMs 500 or from an array of real or virtual images of SLMs. In some exemplary embodiments, the optical structure of a SLM based light system is similar to the optical design described with the array of optical fiber bundles. Output from SLMs 501 . . . 508 of array 500 is emitted through a lens array 30 to provide an array of Köhler like illumination. Additionally or alternatively according to some embodiments of the present invention, effective light sources are obtained by arrays of individually addressable LEDs.

Examples of such use of LED array is shown in WO 2010/010556 published 28 Jan. 2010 in particular FIG. 16 incorporated herein by reference in its entirety. The lenses in lens array 30 are positioned side by side with no spaces between them so that output from SLM array 500 can provide continuous elongated strip of illumination. Optionally, as explained above in reference to FIG. 1, the light beams coming from SLMs 500 are separated by suitable light absorbing baffles (not shown) to minimize crosstalk or light leakage between neighboring source/lens pairs. Optionally, a field lens 40 is used to converge the array of Köhler like illumination toward an optical imaging lens after reflection off a target surface.

In some exemplary embodiments, SLM array 500 is mounted in a row, each one in front of its corresponding lens in lens array 30. Optionally, the SLMs are mounted each on a PCB providing it with electrical power and signals needed for its operation under computer control. Alternatively, all SLMs are mounted on one PCB.

The SLMs may be provided with appropriate lighting in manners well known in the art, such as oblique incident lighting for DMD type SLMs or normally incident polarized illumination with a polarizing beam splitter for LCoS devices.

Reference is now made to FIG. 8B an exemplary schematic diagram of optical components of a SLM light source feeding into an optical fiber bundle of a lighting system in accordance with some embodiments of the present invention. Optionally a light source system 250 that includes a SLM, e.g. DMD 501 and emits light with a shape defined by the SLM for example as described in U.S. Pat. No. 6,464,633 which is incorporated herein by reference.

In some exemplary embodiments, light source system 250 includes a lamp 241 for emitting an illumination light, a lamp power supply 240 for supplying a power to the lamp 241, a parabolic mirror 242 on which a film having infrared transmission characteristics for outgoing the illumination light emitted from the light source lamp 241 as a parallel light is coated, and a DMD 501 for reflecting the parallel light from the parabolic mirror 242 through a lens 515 to condense the parallel light to the incident end of the light guide 28. Typically, a DMD drive circuit 245 controls operation of DMD 501. Reference is now to FIGS. 8C and 8D showing SLM images used to provide dark field illumination and bright field illumination respectively in accordance with some embodiments of the present invention. According to some embodiments of the present invention, each of SLMs can be programmed to provide a predefined shape of illumination. According to some embodiments of the present invention, when each of the SLM projects a same image, the illumination across the entire illuminated region will be spatially invariant so that the illuminating angular field remains the same. In some exemplary embodiments, a SLM is programmed to provide a ring shape illumination with a SLM image 580 such that the dark inner diameter of the ring is equal to or larger than the cone of light admitted by the entrance pupil of the imaging lens. In some exemplary embodiments, the ring shaped illumination can provide dark field illumination on demand. Bright field illumination may be provided by a circular shaped illumination with a diameter that is equal to or less than the diameter of the cone of light admitted by the entrance pupil of the imaging lens. In some exemplary embodiments, a SLM image 570 is used to provide a bright field illumination. The direct SLM illumination architecture of FIG. 8A allows any arbitrarily shaped angular field that can be “written” into the SLM to be projected. In contrast, the fiber optics coupled architecture of FIG. 8B may be limited to circularly-symmetric angular field shapes due to the “circularizing” properties of the fiber.

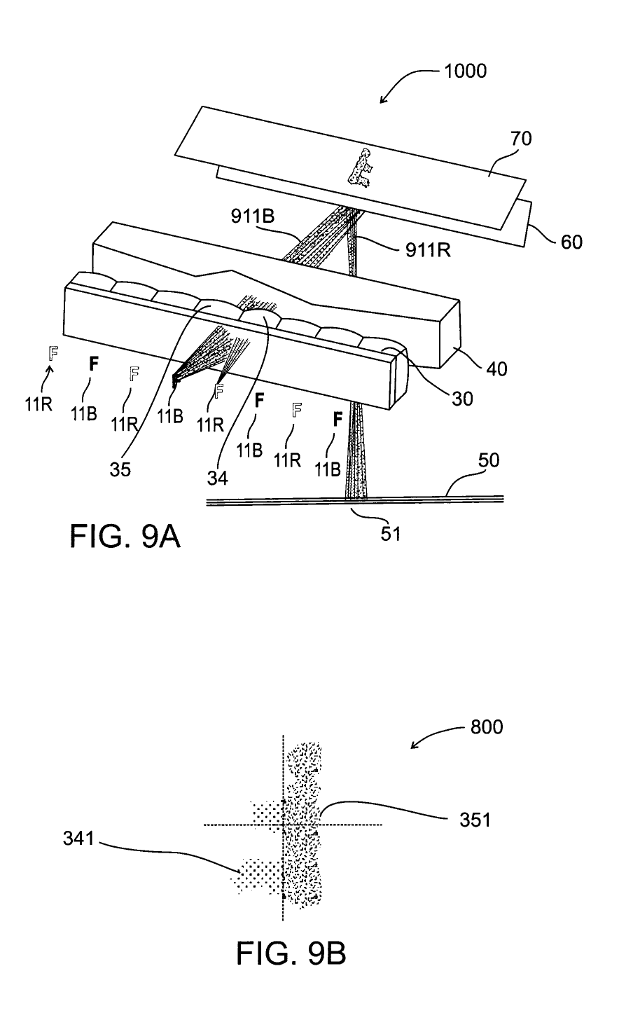

Reference is now made to FIGS. 9A and 9B showing an exemplary schematic diagram of a lighting path and output of a SLM based lighting system over an area on the target object bordering between two neighboring lenses of the lighting system in accordance with some embodiments of the present invention. For illustration purposes, an array of light sources projecting a particular spatial shape 11 resembling a letter ‘F’ with two alternating colors (11R and 11B) are shown. An ‘F’ shape is often used to illustrate the operation of optical systems due to its asymmetric properties. The ‘F’ shape shown in FIG. 9B illustrates how the shape of the source is imaged onto the plane of the entrance pupil of imaging lens 110 from rays 911B and 911R emerging from two neighboring light sources projecting through neighboring lenses 34 and 35.

According to some embodiments of the present invention, the net effect of illumination architecture of lighting system 1000 is to form an ‘F’ shaped bright field angular distribution at every point within the elongated inspected region on target object 50. As can be appreciated, at substrate points located right under a central region of one of lenses of the array 30, the illumination, e.g. from one of ray bundles 911R or 911B, will be provided by one corresponding light source (either 11R or 11B) mounted in front of the lens and a ‘F’ shaped bright field angular distribution will be formed in one of the alternating colors.

According to some embodiments of the present invention, in a sub-region 51 on the substrate offset from a central region of one of the lenses of array 30, e.g. in a region between a center of lens 34 and a center of lens 35, illumination will be provided by two neighboring light sources. According to some embodiments of the present invention, although light is being received from two different light sources, the illuminating angular field remains the same and a full ‘F’ shaped angular field is provided. The different colors show the different contribution from each of the lenses that are fused seamlessly into a single field. As shown in FIG. 9B, the discrete ‘F’ shaped images of light sources 11B and 11R formed by rays passing through region 51 coincide within an imaging lens aperture of an imaging unit and provide continuous spatially invariant illumination along the illuminated region. FIG. 9B depicts actual simulation results, hence the apparent “noise” that is only due to the finite number of light rays used in the simulation.

In some exemplary embodiments, this seamless spatially invariant angular field is a result of placing the light sources such that they are each imaged into the imaging lens aperture. This avoids the progressive illumination vignetting typically present in wide field of view imaging of specular surfaces, thus ensuring that all points within the field of view are evenly illuminated. In this sense the system operates as a quasi-telecentric system, whereas a strictly telecentric system has its entrance pupil located at infinity. That uniformity property is further due to the integral design of the lens array that avoids gaps between neighboring lenses. By use of a SLM any arbitrary shift invariant angular field at any point on the inspected substrate can be projected.

Optionally, by varying the spatial shape of the light sources other arbitrary angular illumination distributions may be achieved, e.g. bright field, dark field and any combination thereof.

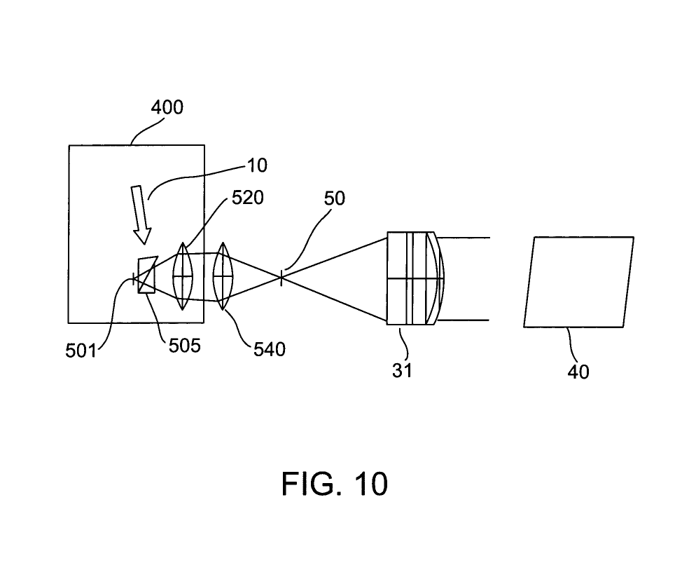

Reference is now made to FIG. 10 showing an exemplary schematic diagram of a SLM based light system with an integrated projection light engine in accordance with some embodiments of the present invention. According to some embodiments of the present invention, each discrete light source is effectively formed using a SLM based integrated projection light engine 400. Available integrated light engines may suitably include DMD based light engines provided by Young Optics Inc. of China and LCoS based light engines provided by Greenlight Optics, LLC of the US.

The projection light engine 400 typically includes a light source assembly comprising LEDs or diode lasers, often emitting light in the primary red, green and blue colors. The light 10 is typically brought to impinge on the SLM device 501, e.g. a DMD with a beam splitting prism 505. In some known applications of projection light system, a projection lens 520 forms an image of the SLM surface on the display screen, typically a distance ranging from 0.5 meters to 2 meters from the projector device. According to some embodiments of the present invention, the light engine is adapted for use as lighting system for AOI by using a relay lens 540 to form an image, either real or virtual, at the appropriate location relative to a lens 31 (of lens array 30). According to some embodiments of the present invention, lens 31 either alone or in combination with field lens 40 operates to image the SLM's image onto a plane on an aperture stop of the imaging lens as described herein above. In some exemplary embodiments, for applications demanding dark field illumination, pixels that are imaged within the aperture are turned to an OFF position and pixels that are imaged outside the aperture are turned to an ON position. It is noted that although only one light engine 400 and one lens 31 is shown for clarity purposes, an elongated illumination field according to embodiments of the present invention is obtained with an array of light engines 400 projecting to an array of lenses 30 as described herein above.

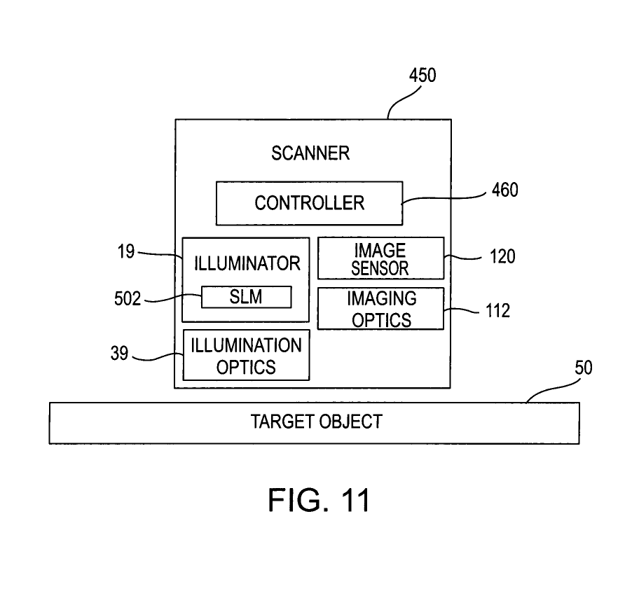

Reference is now made to FIG. 11 showing an exemplary block diagram of a scanning system for Automated Optical Inspection (AOI) that includes a lighting system in accordance with some embodiments of the present invention. According to some embodiments of the present invention an AOI system includes an image acquisition subsystem 450 and a handling system, such as a stage (not shown). The image acquisition subsystem 450 typically comprises an image sensor 120 with associated imaging optics 112 for capturing images of a target object 50 during scanning; an illuminator 19 with associated illumination optics 39 for illuminating a field of view of the image sensor 120. Optionally, illuminator 19 includes one or more SLMs 502 for modifying properties, e.g. angular shape of its light source on demand as required for different applications.

Typically image acquisition subsystem 450 includes a controller 460 for coordinating the relative positioning and movement of target object 50 and image acquisition subsystem 450 as well as with the illumination periods of illuminator 19 and image capture with image sensor 120. According to embodiments of the present invention, during operation, a target object 50, e.g. a panel to be inspected, is inserted into the AOI system and is scanned by image acquisition subsystem 450. Optionally, images are acquired using different illumination configurations as the panel advances. According to some embodiments of the present invention, output from image sensor 120 is analyzed and reported, e.g. in the form of a defect report.

According to some embodiments of the present invention, illuminator 19 includes one or more (e.g. an array) LED lamps, an array of optical fiber bundles, and/or an array of integrated projection light engines. According to some embodiments of the present invention, illumination optics 39 includes lens array that provides an array of Köhler-like illuminations. Optionally illumination optics 39 additionally includes a field lens for directing reflected light into an entrance pupil of imaging optics 112. Typically illumination optics 39 additionally includes a reflector and/or beam splitter positioned to direct illumination from illuminator 19 toward target object 50 and project light reflected from target object 50 toward image sensor 120.

According to some embodiments of the present invention, image sensor 120 may be a linear or TDI type image sensor that captures images of an elongated field of view preferably having an aspect ratio of 40:1 or more. According to some embodiments of the present invention, illuminator 19 with illumination optics 39 provides illumination over an area with a substantially smaller aspect ratio as the field of view of image sensor 120. According to some embodiments of the present invention, the illumination provided is spatially invariant over the area of illumination in the sense that the angular field is the same for all points within the illuminated area.

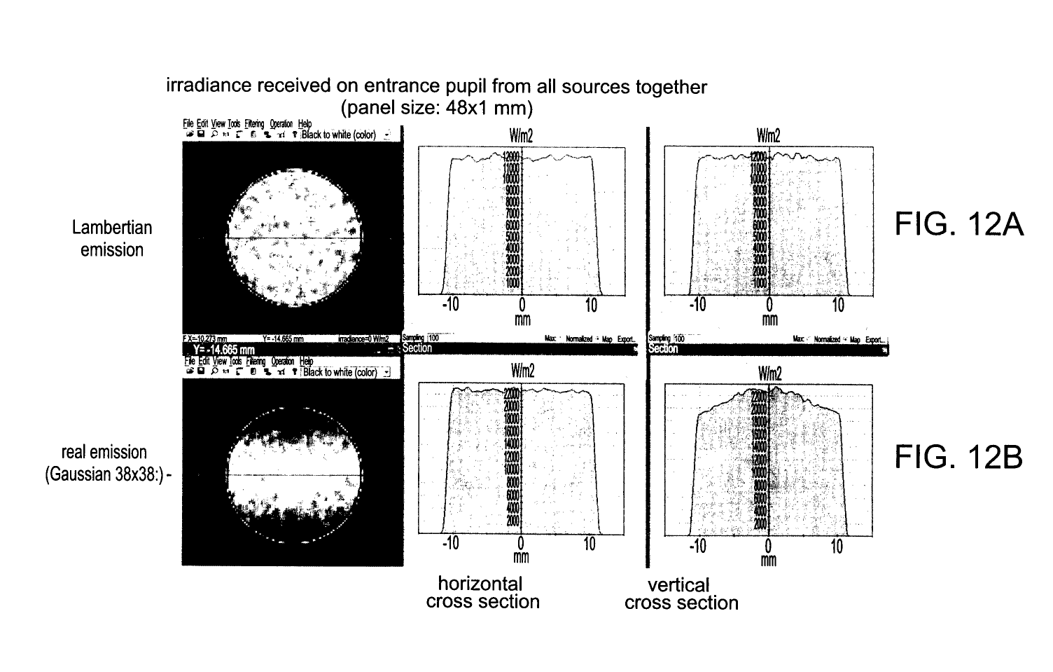

Reference is now made to FIGS. 12A and 12B comparing irradiance received on entrance pupil in an exemplary simulation using the lighting system in accordance with some embodiments of the present invention. The simulation computed the superimposed images of an array of 8 circular light sources 20 falling on the plane of imaging lens, e.g. imaging lens 110 entrance pupil (FIGS. 2A-2B). The images were formed by light rays collected from a field of view measuring 48 mm by 1 mm on an inspected surface. Such a field of view is typical of TDI type linear cameras. The lens aperture was located about 250 mm from the inspected surface. The analysis was performed for both Lambertian, (e.g. LED illumination) and Gaussian angular emission on the part of the light sources. As the Figures clearly show, a well defined circular image was formed in both cases, corresponding to a pure bright-field illumination subtending a 5° full angle at the object. The Lambertian emitting source yielded a more uniformly illuminated pupil as evidenced by its “flatter” horizontal and vertical cross sections. This demonstrates the capability of illumination systems built in accordance with the invention to generate vignetting-free quasi-telecentric Köhler-like illumination over an elongate field of view, using a non-telecentric imaging lens. The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

1-56. (canceled)

57. A method for illuminating an elongated field of view of a linear or high aspect ratio area image sensor, the method comprising:
providing illumination with an elongated field shape with a plurality of discrete light sources; and
projecting the illumination toward an object to be imaged; wherein the illumination projected on the object is substantially spatially invariant in intensity and angular distribution along the elongated field shape on the object.

58. The method according to claim 57 comprising imaging the projected illumination to an imaging lens entrance pupil of an imaging unit for imaging the object, wherein a diameter of the entrance pupil is at least one order of magnitude less than a distance between the object and the imager.

59. The method according to claim 58, wherein the field of view of the imager has an aspect ratio larger than 40:1.

60. The method according to claim 57, wherein the illumination is non-vignetting over the elongated field of view.

61. The method according to claim 57, wherein the illumination provided is adapted to non-telecentric imaging of the elongated field of view.

62. The method according to claim 57, wherein the illumination provided is output from a Spatial Light Modulator (SLM).

63. The method according to claim 57, wherein the illumination with an elongated field shape is provided with an array of light sources projected through an array of lenses, wherein the lenses in the array are contiguous with no space between them.

64. The method according to claim 63, wherein each light source and corresponding lens projects a discrete portion of illumination toward the elongated field of view with an angular shape substantially similar to the shape of the light source and wherein the discrete portions of illumination are contiguous with substantially no space between them and provide illumination over the elongated field of view.

65. The method according to claim 63, wherein illumination projected from each light source through each corresponding lens of the array of light sources and the array of lenses is Köhler-like illumination.

66. The method according to claim 63 comprising directing illumination projected through all the lenses of the lens array into the imaging lens aperture of an image sensor.

67. The method according to claim 66, wherein the directing is provided with a field lens.

68. The method according to claim 63, wherein the light sources of the array are narrow angle light sources each of which emit over a total angle of 25 to 35 degrees.

69. The method according to claim 63, wherein an aspect ratio of the array of lenses is less than 10:1.

70. The method according to claim 63, wherein the array of light sources is formed with a SLM based integrated projection light engine.

71. The method according to claim 70, wherein the SLM provides one of bright field or dark field illumination.

72. The method according to claim 71, wherein the SLM provides dark field illumination with a ring shaped illumination formed with the SLM and wherein an inner diameter of the ring shaped illumination is defined to be equal to or larger than the entrance pupil of an imaging lens for imaging the elongated field of view.

73. The method according to claim 71 , wherein the SLM provides bright field illumination with a circular shaped illumination formed with the SLM, wherein a diameter of the circular shaped illumination is equal or smaller than entrance pupil of an imaging lens for imaging the elongated field of view.

74. A lighting system for illuminating an elongated field of view of a linear or high aspect ratio area image sensor comprising:
an array of lenses, wherein the lenses in the array are contiguous with no space between them;
an array of light sources, each having a shape, wherein each light source in the array of light sources is positioned to project light through a corresponding lens in the array of lenses; and
wherein each light source and corresponding lens projects a discrete portion of illumination toward the elongated field of view with an angular shape substantially similar to the shape of the light source and wherein the discrete portions of illumination are contiguous with substantially no space between them and provide illumination over the elongated field of view.

75. The lighting system of claim 74 wherein each light source and corresponding lens of the array of light sources and the array of lenses provides Köhler-like illumination.

76. The lighting system of claim 74 wherein the light sources of the array are narrow angle light sources each of which emit over a total angle of 25 to 35 degrees.

77. The lighting system of claim 74, wherein the elongated field of view has an aspect ratio larger than 40:1.

78. The lighting system of claim 74, wherein an aspect ratio of the array of lenses is less than 10:1.

79. The light system of claim 74, wherein the illumination from the array of light sources is imaged onto an imaging lens entrance pupil of an imaging unit for imaging the object, wherein a diameter of the entrance pupil is at least one order of magnitude less than a distance between the object and the imager.

80. The lighting system according to claim 74 further comprising a field lens, wherein the field lens is adapted to direct illumination projected through all the lenses of the lens array into the imaging lens aperture of an image sensor.

81. The lighting system according to claim 74, wherein the array of light sources is angled in a crescent shape, said crescent defined to direct illumination into an imaging lens aperture of an image sensor.

82. The lighting system according to claim 81, wherein the array of lenses are angled in a crescent shape, said crescent shape defined to direct illumination into an imaging lens aperture of an image sensor.

83. The lighting system according to claim 74, wherein the array of light sources is output from an array of SLMs.

84. The lighting system according to claim 74, wherein the array of light sources is formed with a SLM based integrated projection light engine.

85. The lighting system according to claim 83, wherein the SLM provides one of bright field or dark field illumination.

86. The lighting system according to claim 83, wherein the SLM provides dark field illumination with a ring shaped illumination formed with the SLM.

87. The lighting system according to claim 86, wherein an inner diameter of the ring shaped illumination is defined to be equal to or larger than the entrance pupil of an imaging lens for imaging the elongated field of view.

88. The lighting system according to claim 85, wherein the SLM provides bright field illumination with a circular shaped illumination formed with the SLM, wherein a diameter of the circular shaped illumination is equal or smaller than entrance pupil of an imaging lens for imaging the elongated field of view.
